(19) United States
(12) Patent Application Publication
(10) Pub. No.: US 2013/0287053 A1
(43) Pub. Date: Oct. 31, 2013

(54) METHOD AND DEVICE FOR EMITTING A LASER BEAM IN A HOUSING

(71) Applicants: Virgine Zeninari, Reims Cedex 2 (FR); Bertrand Parvitte, Reims Cedex 2 (FR); Lilian Joly, Reims Cedex 2 (FR); Vincent Lecocq, Quinte Fonsegrives (FR); Georges Durry, Reims Cedex (FR); Regis Hamelin, Castelmaurou (FR); Ronan Le Loarer, Reims Cedex 2 (FR)

(72) Inventors: Virgine Zeninari, Reims Cedex 2 (FR); Bertrand Parvitte, Reims Cedex 2 (FR); Lilian Joly, Reims Cedex 2 (FR); Vincent Lecocq, Quinte Fonsegrives (FR); Georges Durry, Reims Cedex (FR); Regis Hamelin, Castelmaurou (FR); Ronan Le Loarer, Reims Cedex 2 (FR)

(73) Assignee: UNIVERSITE DE REIMS CHAMPAGNE ARDENNE, Reims Cedex (FR)

(21) Appl. No.: 13/994,996

(22) PCT Filed: Dec. 13, 2011
(86) PCT No.: PCT/FR2011/052970

§ 371 Date: Jul. 9, 2013

(30) Foreign Application Priority Data
Dec. 15, 2010 (FR) 1060587

(51) Int. Cl. H01S 3/04

(52) U.S. Cl. CPC H01S 3/04
USPC 372/36; 29/592.1

(57) ABSTRACT

A device for emitting a laser beam comprises, in a housing, a laser-emitting component emitting a laser beam and mounted on a base, a heat-dissipating component, at least one collimating lens, and a lens mounting. The heat-dissipating component dissipates the heat produced by the laser of the laser-emitting component and secures the base of the laser-emitting component. The heat-dissipating component has a positioning mark and at least three holes for centering pins machined together with the positioning mark. The lens mounting secures the lens opposite the laser-emitting component and is positioned relative to the heat-dissipating component by at least three centering pins positioned in the holes of the heat-dissipating component.

### RELATED APPLICATIONS

This application is a §371 application from PCT/FR2011/052970 filed Dec. 13, 2011, which claims priority from French Patent Application No. 1060587 filed Dec. 15, 2010, each of which is herein incorporated by reference in its entirety.

### TECHNICAL FIELD OF INVENTION

This invention relates to a method and a device for emitting a laser beam in a housing. This invention makes it possible, for example, to be fitted to a spectrometer with a view to performing gas detection.

### BACKGROUND OF THE INVENTION

A compact mid-infrared laser is known from document WO 2007/050134, which comprises a rigid system (2) where the respective positioning of the lens (14) and the laser source (6) is linked to the dimensions of the parts (see page 13, lines 24-26, page 14, lines 17-26, page 17, line 29 to page 18, line 2), without performing either active positioning, i.e. by turning on the laser source, or passive positioning, i.e. without turning on the laser source. This system does not therefore have repeatable, sufficiently precise positioning accuracy.

### OBJECT AND SUMMARY OF THE INVENTION

This invention aims to remedy all or part of these drawbacks.

To this end, according to a first aspect, the present invention envisages a device for emitting a laser beam, which comprises, in a housing:
a component emitting a laser beam and being mounted on a base;
a component for dissipating the heat produced by the laser of the laser-beam emitter component and to which the base of the emitter component is secured, the heat-dissipating component having a positioning mark and at least three holes for centering pins machined together with the positioning mark;
at least one collimating lens; and
a lens mounting suitable for holding each said lens in front of the component emitting the laser beam, said lens mounting being positioned relative to the heat-dissipating component by means of at least three centering pins positioned in the holes of the heat-dissipating component.

Utilizing this invention makes possible an alignment accuracy of at least 10 μm, in particular because the cooling component is machined to form the positioning mark and the holes for centering pins at the same time.

In addition, these provisions also allow passive positioning, i.e. without turning on the laser source, which is both simpler and less costly than active positioning, where the laser source is turned on and mechanical elements are moved until the laser radiation is configured as required.

According to particular features, the lens mounting comprises two lateral notches and a central through-aperture, the lateral notches and the central through-aperture being positioned to allow the passage of three centering pins inserted into the holes for centering pins.

According to particular features, the lateral notches are oriented perpendicular to the through-aperture.

According to particular features, the lateral notches are delimited by flexible tabs of the lens mounting.

Thanks to each of these provisions, once the device has been mounted three centering pins are inserted, firstly and respectively, into the two lateral notches and central through-aperture of the lens mounting; then, secondly, into the holes of the radiating element. The lateral notches being slightly flexible, due to the lower tab that delimits them, the centering pins are held firmly in position relative to the lens mounting. The through-aperture ensures that the lens mounting is accurately positioned on an axis perpendicular to that of the lateral notches. The lens mounting is thus positioned and held in position with an alignment accuracy on two axes of at least 10 μm.

According to particular features, the emitter component is arranged parallel to the support surface of the housing.

According to particular features, the housing is equipped with an external outlet for conductive links connected, inside the housing, to the connectors of the emitter component.

According to particular features, the emitter component is a quantum cascade laser.

According to particular features, the housing also comprises a Peltier-effect cooling component.

According to particular features, said positioning mark is a notch.

According to a second aspect, this invention envisages a method of manufacturing a device for emitting a laser beam, which comprises:
a step of simultaneously machining a positioning mark and at least three holes for centering pins on a heat-dissipating component;
a step of assembling a component emitting a laser beam on the surface of the heat-dissipating component bearing said positioning mark; and
a step of assembling at least one collimating lens in a lens mounting suitable for holding each said lens in front of the component emitting the laser beam, positioning said lens mounting relative to the heat-dissipating component, by means of at least three centering pins mounted in three said holes.

According to a third aspect, this invention envisages a device for spectroscopic gas analysis, which comprises a device for emitting a laser beam according to this invention and a cell wherein the gas to be analyzed is, said cell being traversed by said laser beam.

As the particular characteristics, advantages and aims of this gas analysis method and device are similar to those of the device for emitting a laser beam that is the subject of this invention, they are not repeated here.

### BRIEF DESCRIPTION OF THE DRAWINGS

Other advantages, aims and characteristics of this invention will become apparent from the description that will follow, made, as an example that is in no way limiting, with reference to the drawings included in an appendix, in which:

FIG. 1 represents, schematically and in perspective, elements of a compact assembly of a laser radiant energy source,

FIG. 2 represents, schematically and in perspective, the elements shown in FIG. 1, assembled,

FIG. 3 represents, schematically and in perspective, elements of a sub-assembly of the compact assembly comprising the elements shown in FIGS. 1 and 2,

FIG. 4 represents, schematically and in perspective, the assembling of the elements shown in FIGS. 1 and 3 to form a laser radiant energy source,

FIG. 5 represents, in the form of a logical diagram, steps utilized in a particular embodiment of the method that is the subject of this invention.

### DETAILED DESCRIPTION OF EMBODIMENTS

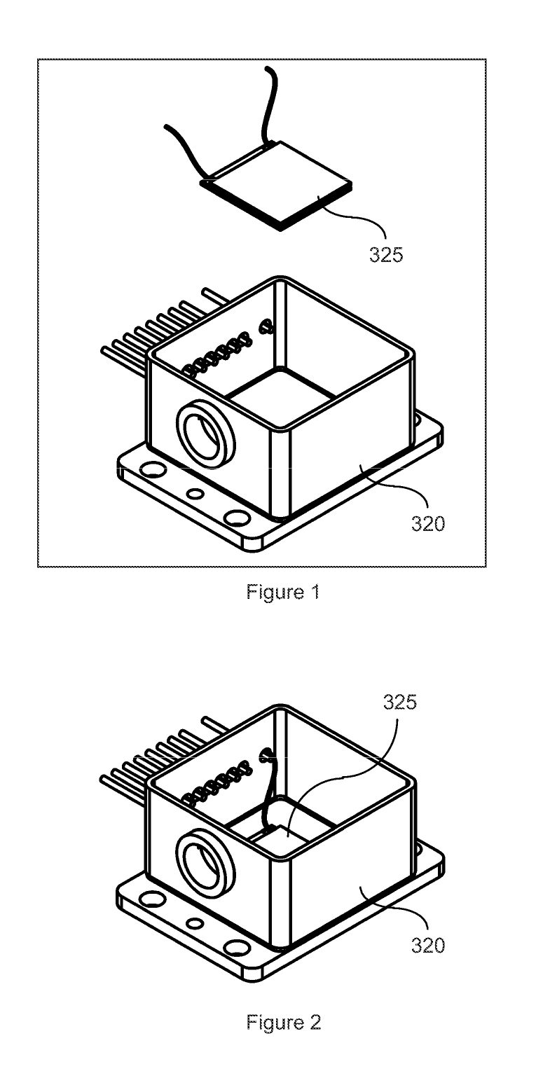

FIG. 1 shows a sub-assembly comprising a housing 320 and a cooling component 325 based on the Peltier effect. It is noted that, in an option, AlN non-metallized ceramic with “pre-tinned” copper power supply wires is utilized here. These elements are shown apart in FIG. 1 and assembled in FIG. 2. The contact surface of the housing 320 is, in FIGS. 1 and 2, the lower surface.

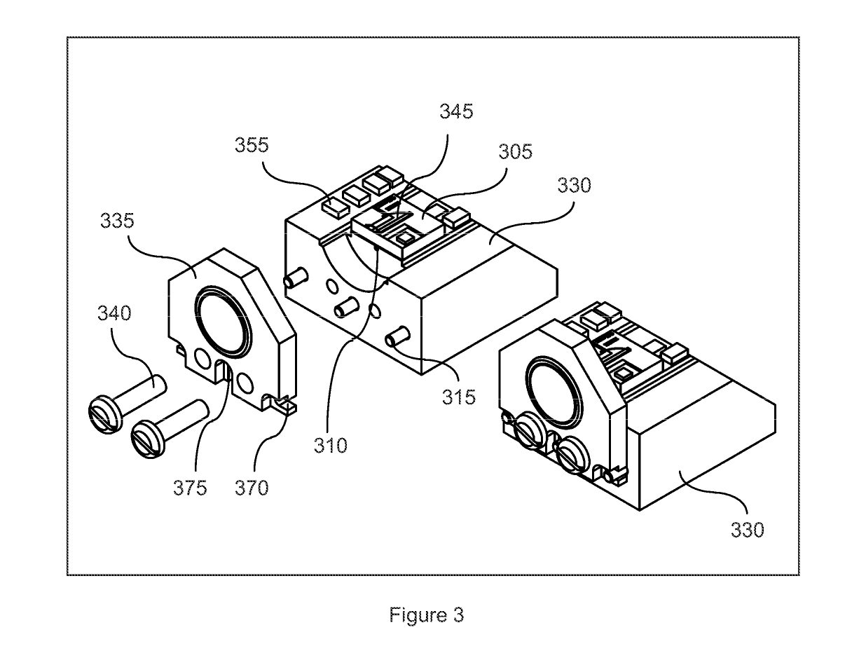

FIG. 3 shows, in an exploded form on the left and in an assembled form on the right, a quantum cascade laser module comprising a radiating element 330, an optical sub-assembly of a lens and a frame forming the lens mounting 335, two screws 340 for assembling the optical sub-assembly 335 onto the radiating element 330, a quantum cascade laser component 345 mounted on a base 305, a thermistor 360, several electrical connecting components forming conductor relays 355.

The radiating element 330, also referred to as “heat-dissipating component”, dissipates the heat coming from the laser component 345. The lens/frame sub-assembly 335 comprises two lateral notches 370 and a central through-aperture 375. These three openings allow the passage of three centering pins 315.

The heat-dissipating component 330 bears a positioning mark, on the upper surface. In the embodiment shown in the figures, the positioning mark 310 is a notch.

After being mounted on the base 305, the laser 345 is precisely positioned relative to the positioning mark 310. This positioning is preferably performed using a stereoscopic microscope, a microscope or by means of an automatic mounting machine's shape recognition software.

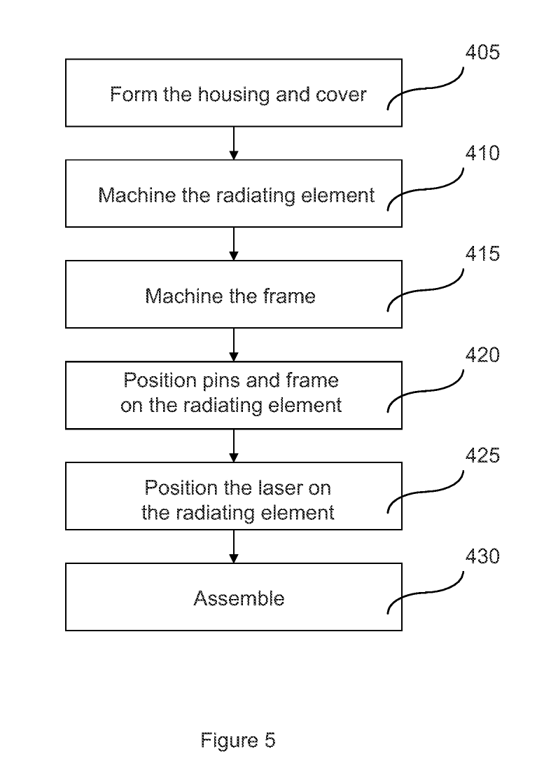

As described with reference to FIG. 5, the notch 310 and three holes 385 for receiving the centering pins 315 are formed at the same time during the same step of machining the heat-dissipating component 330, i.e. their machining operations are not separated by removal of the radiating element 330. It is noted that the component 345 emitting the laser beam is arranged parallel to the support surface of the housing 320.

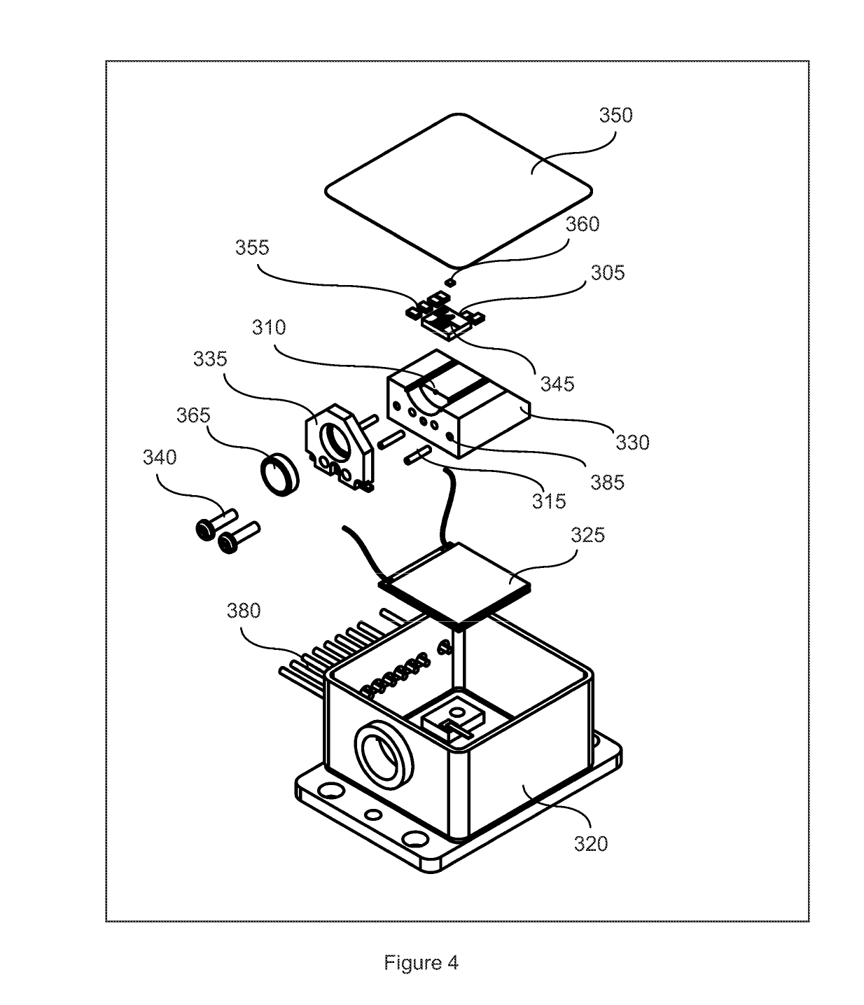

FIG. 4 shows the assembly of the elements shown in FIGS. 1 and 3, the frame of the optical assembly 335 being fitted with a convex lens 365 and a housing cover 350 closing the housing 320. The housing 320 is equipped with an external outlet 380 for conductive links connected to the connectors of the emitter component, inside the housing.

Thus, once the device has been mounted three centering pins 315 are inserted, first of all respectively into the two lateral notches 370 and central through-aperture 375 of the lens mounting 335 and secondly into the holes 385 of the radiating element 330.

The lateral notches 370 are oriented perpendicular to the through-aperture 375. The lateral notches 370 are delimited by flexible tabs of the lens mounting 335.

The lateral notches 370 being slightly flexible, due to the lower tab that delimits them, the centering pins 315 are held firmly in position relative to the lens mounting. The through-aperture 375 ensures that the lens mounting 335 is accurately positioned on an axis perpendicular to that of the lateral notches 370. The lens mounting is thus positioned and held in position with accuracy on two axes of at least 10 μm.

Although FIGS. 1 to 4 show three centering pins 315 and three holes 385 for centering pins, this invention is not limited to this number of pins and holes, but on the contrary extends to all devices comprising at least two centering pins 315 and a number of holes 385 at least equal to the number of centering pins 315, said holes being machined at the same time as the positioning mark 310.

As shown in FIG. 5, during a step 405, the housing 320 and the cover 350 are formed. During a step 410, the radiating element 330 is machined and, without removal, the notch 310 and the holes 385 for pins 315 are formed. During a step 415, the frame of the optical assembly 335 is machined.

During a step 420, the pins 315 are positioned in the holes 385, the lens 365 is positioned in the frame of the optical assembly 335 and this frame is positioned on the pins 315. Then, the screws 340 are fitted to clamp the frame of the optical assembly 335 onto the radiating element 330.

During a step 425, the laser 345 is positioned accurately relative to the notch 310. This positioning is preferably performed using a stereoscopic microscope, a microscope or by means of an automatic mounting machine's shape recognition software.

During a step 430, the other parts shown in FIGS. 1, 3 and 4 are assembled.

This invention applies, in particular, to enclosing laser radiation from a quantum cascade laser within a housing. In particular, this housing can be used in association with a photo-acoustic or direct absorption spectrometer for detecting traces of gas.

1-11. (canceled)

12. Device for emitting a laser beam, comprising in a housing:
an emitter component for emitting a laser beam and mounted on a base;
at least one collimating lens;
a heat-dissipating component for dissipating the heat produced by a laser of the laser emitting component and securing the base of the emitter component, the heat-dissipating component having a positioning mark and at least three holes for centering pins machined together with the positioning mark; and
a lens mounting for holding said at least one collimating lens in front of the emitting component, the lens mounting being positioned relative to the heat-dissipating component by at least three centering pins positioned in the holes of the heat-dissipating component.

13. Device according to claim 12, wherein the lens mounting comprises two lateral notches and a central through-aperture, the lateral notches and the central through-aperture being positioned to allow passage of said at least three centering pins inserted into the holes for centering pins.

14. Device according to claim 13, wherein the lateral notches are oriented perpendicular to the through-aperture.

15. Device according to claim 14, wherein the lateral notches are delimited by flexible tabs of the lens mounting.

16. Device according to claim 13, wherein the lateral notches are delimited by flexible tabs of the lens mounting.

17. Device according to claim 12, wherein the emitter component is arranged parallel to a support surface of the housing.

18. Device according to claim 12, wherein the housing comprises an external outlet for conductive linking with connectors of the emitter component inside the housing.

19. Device according to claim 12, wherein the emitter component is a quantum cascade laser.

20. Device according to claim 12, wherein the housing comprises a Peltier-effect cooling component.

21. Device according to claim 12, wherein the positioning mark is a notch.

22. Device for spectroscopic gas analysis, comprising a device for emitting a laser beam according to claim 12 and a cell containing a gas to be analyzed, said cell being traversed by said laser beam.

23. Method of manufacturing a device for emitting a laser beam, comprising the steps of:
simultaneously machining a positioning mark and at least three holes for centering pins on a heat-dissipating component;
assembling an emitter component emitting a laser beam on the surface of the heat-dissipating component bearing said positioning mark;
assembling at least one collimating lens in a lens mounting suitable for holding said at least one collimating lens in front of the emitter component; and
positioning said lens mounting relative to the heat-dissipating component by at least three centering pins mounted in said at least three holes.
